(19) United States
(12) Patent Application Publication
(10) Pub. No.: US 2006/0136658 A1
(43) Pub. Date: Jun. 22, 2006

(54) DDR2 SDRAM memory module

(75) Inventor: Lonny L. Brown, Huntington Beach, CA (US)

Correspondence Address: MCDERMOTT WILL & EMERY LLP, 18191 VON KARMAN AVE., SUITE 500, IRVINE, CA, 92612-7108, US

(73) Assignee: SimpleTech, Inc., Santa Ana, CA (US)

(21) Appl. No.: 11/012,197

(22) Filed: Dec. 16, 2004

(51) Int. Cl. G06F 12/00

(52) U.S. Cl. 711/105; 711/115

(57) ABSTRACT

A DDR2 SDRAM memory module having memory chips arranged bilaterally symmetrical on the module. A register chip is arranged on each of two faces of the memory module, with each register chip coupled to half of the memory chips.

### FIELD OF THE INVENTION

The present invention concerns computer memory modules and in particular concerns DDR2 SDRAM memory modules.

### BACKGROUND OF THE INVENTION

Random access memory (RAM) plays a critical role in the operation of computing systems. The performance of computing systems and the software applications executed thereon depends on both the capacity and the speed of the RAM modules used. As software applications become more complex and work with larger amounts of data, RAM modules having both larger capacities and higher speeds are needed. While some improvement in performance can be attained by increasing the density and improving the quality of the memory integrated circuits used to make the RAM modules, new memory architectures are required to meet the continually increasing demands of software applications.

Synchronous dynamic random access memory (SDRAM) has been developed to provide high performance memory modules. Among the different implementations of SDRAM, the Joint Electron Device Engineering Council (JEDEC) has established standards for double data rate (DDR) SDRAM and DDR2 SDRAM. DDR and DDR2 SDRAM are memory architectures which potentially double the rate of data transfers by utilizing both the rising and falling edges of each clock cycle for transferring data. However, these architectures currently leave room for further performance improvements.

FIGS. 1A and 1B are schematic diagrams depicting the two faces of a conventional DDR2 SDRAM registered dual in-line memory module (RDIMM) 10. Each face of RDIMM 10 includes eighteen SDRAM memory chips 12 and two register chips 14 mounted thereon. As shown in FIGS. 1A and 1B, the arrangement of memory chips 12 is asymmetrical on the face of RDIMM 10. Specifically, memory chips 12 are split into a group of ten chips and a group of eight chips on each face. In addition to the asymmetrical layout of memory chips 12, register chips 14 are also coupled with memory chips 12 in an asymmetrical manner, with two register chips 14 coupled to twenty memory chips 12 and two register chips 14 coupled to sixteen memory chips 12.

The asymmetrical configuration of conventional DDR2 SDRAM memory modules creates limitations on the ability to improve performance of the memory module. For example, each memory chip 12 places a capacitive load on the outputs of register chips 14 to which it is coupled. With twenty memory chips 12 coupled to one pair of register chips 14 and sixteen memory chips 12 coupled to the other pair of register chips 14, the total load placed on the register chip pairs is unequal. This unequal loading results in the post-register timing of the two register chip pairs being skewed. When the post-register timing does not match for the two register chip pairs, changes within a given clock cycle occur at different times and therefore limit the extent to which clock cycles can be shortened to improve the speed of the memory module.

In view of the foregoing, the asymmetrical configuration of conventional DDR2 SDRAM memory modules does not provide an ideal design for improving memory performance. Accordingly, a need exists for an improved design for DDR2 SDRAM memory modules.

### SUMMARY OF THE INVENTION

The present invention addresses the foregoing needs by providing a DDR2 SDRAM memory module on which memory chips are configured using a balanced topology. According to one aspect of the invention, the memory chips are arranged bilaterally symmetrical on the memory module. The memory module further includes two register chips, with one register chip arranged on each of two faces of the memory module. One half of the memory chips are coupled to one register chip and the other half of the memory chips are coupled to the other register chip. Using this topology, load balancing reduces timing skew and improves both pre-register and post-register timing.

According to another aspect of the invention, the memory module uses four register chips, with two register chips arranged on each of two faces of the memory module. One half of the memory chips are coupled to one pair of register chips while the other half of the memory modules are coupled to the other pair of register chips.

Preferably, the memory module is configured with thirty-six memory chips, having eighteen memory chips arranged on each of two faces of the memory module. The memory chips on each face of the memory module are configured bilaterally symmetrical in two groups of nine memory chips.

The foregoing summary of the invention has been provided so that the nature of the invention can be understood quickly. A more detailed and complete understanding of the preferred embodiments of the invention can be obtained by reference to the following detailed description of the invention and the associated drawings.

### BRIEF DESCRIPTION OF THE DRAWINGS

FIGS. 1A and 1B are schematic diagrams depicting the faces of a conventional DDR2 SDRAM memory module.

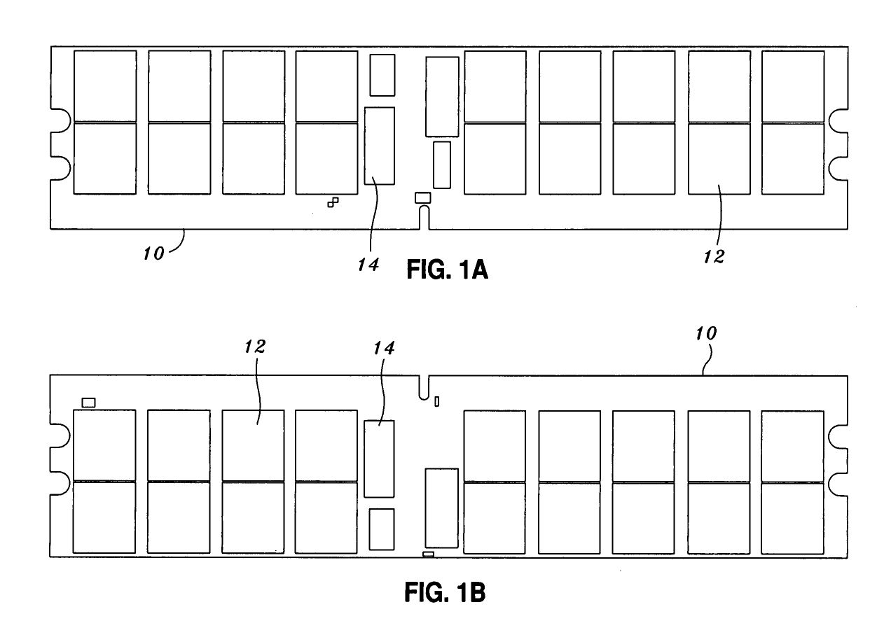

FIGS. 2A and 2B are schematic diagrams depicting the faces of a memory module according to the invention.

FIG. 3 is a schematic diagram depicting the coupling of memory chips to register chips according to the invention.

### DETAILED DESCRIPTION OF THE INVENTION

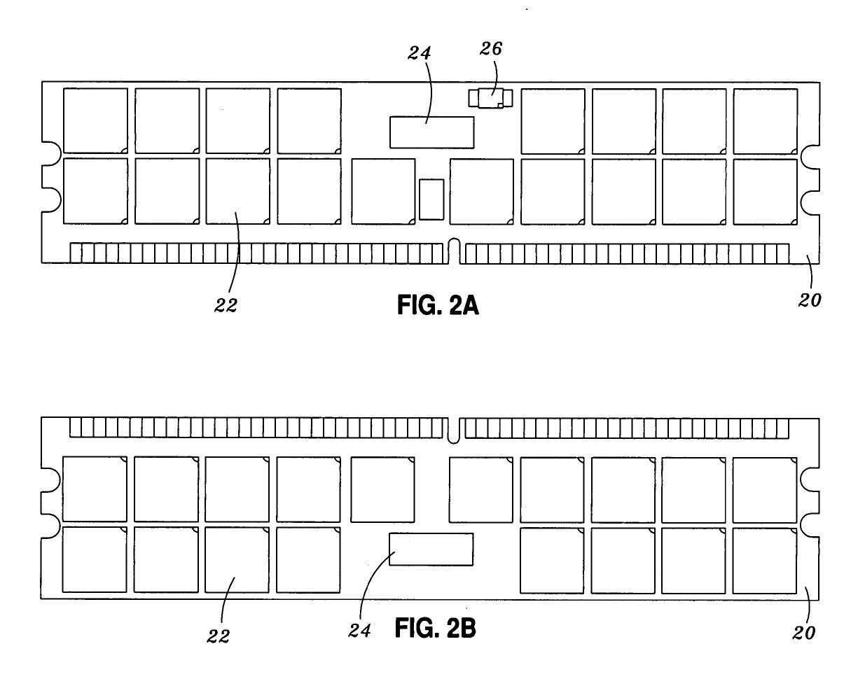

FIGS. 2A and 2B are schematic diagrams depicting an arrangement of components on the two faces of DDR2 SDRAM RDIMM 20 according to the invention. The components arranged on memory module 20 include memory chips 22, register chips 24, and phase-locked loop (PLL) oscillator 26. According to one implementation of the invention, 512 M-bit (128M×4) DDR2 SDRAM chips commercially available from Infineon Technologies AG (parts number HYB18T512400AF-5) are used for memory chips 22, 28-bit registers commercially available from Integrated Circuit Systems, Inc., (parts number ICSSSTUF32868AHLF-T) are used for register chips 24, and a PLL oscillator commercially available from Integrated Circuit Systems, Inc., (parts number ICS97U877HLF-T) is used for PLL oscillator 26. The invention is not limited to the use of these chips, however, and can be implemented using other types of memory chips, registers and PLLs without departing from the scope of the invention. Other components assembled in memory module 20 are well known to those skilled in the art and will not be described herein in order to focus on the features of the present invention.

One significant advantage of the present invention over conventional DDR2 SDRAM modules is the use of a balanced topology in the layout of memory chips 22. As shown in FIGS. 2A and 2B, thirty-six memory chips 22 are configured on memory module 20 by mounting eighteen memory chips 22 in two rows on each face of memory module 20. One row on each face, comprises eight memory chips 22 while the other row comprises ten memory chips 22. The eighteen memory chips 22 are further arranged bilaterally symmetrical on each face in two groups of nine chips. According the embodiment depicted in FIG. 2, memory chips 22 are arranged bilaterally symmetrical with respect to register chip 24 on each face of memory module 20.

Using the configuration described above, memory module 20 provides 2 GB of storage capacity. One skilled in the art will recognize that different memory chips can be used to provide memory modules having different storage capacities. The total number of memory chips 22 can also be varied so long as the overall topology is balanced. One skilled in the art will recognize other possible combinations which do not depart from the scope of the invention.

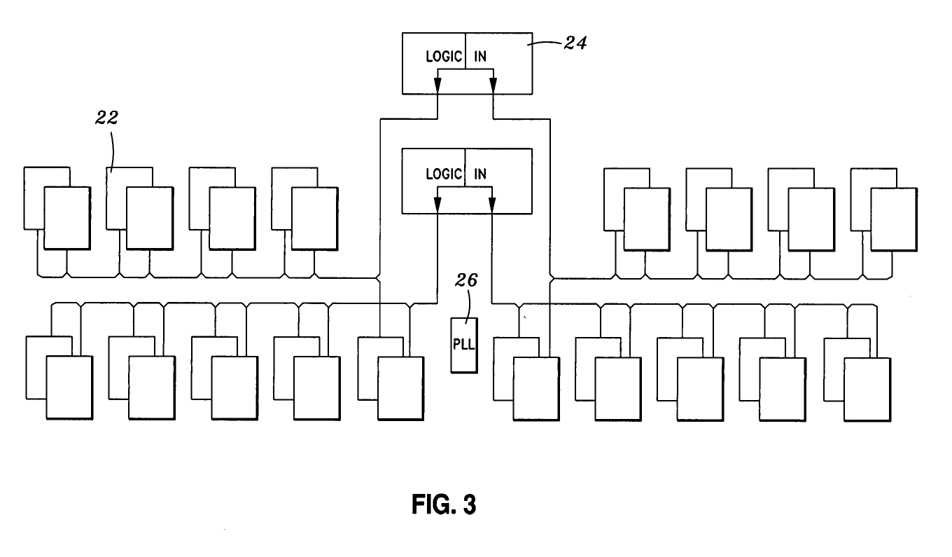

In addition to being arranged using a balance topology, memory chips 22 are coupled to register chips 24 in a balanced manner. FIG. 3 is a schematic diagram depicting the coupling of memory chips 22 to register chips 24. According to the invention, an equal number of memory chips 22 are coupled to each register chip 24. As shown in FIG. 3, one embodiment of the invention couples eighteen memory chips 22 to each register chip 24. This balanced coupling places an even capacitive load on each of register chips 24, which improves post-register timing and minimizes timing skew between the registers. Minimizing timing skew allows shorter clock cycles to be used which improves the speed of memory module 20.

The above-described advantages attained using balanced coupling of memory chips 22 to register chips 24 can also be attained using four register chips 24, with one pair mounted on each side of memory module 20 (this configuration is not shown in the drawings). Using this configuration, 14-bit registers are used as register chips with eighteen memory chips coupled to each pair of register chips. While the four-register configuration provides similar post-register timing advantages, the two-register configuration provides additional advantages described below.

Two advantages provided by the use of two register chips versus four register chips are improved pre-register timing and simplified circuit board routing. With respect to pre-register timing, the input of each register chip adds a capacitive load of typically around 3 to 4 pF. Accordingly, when the number of register chips used is increased in the memory module configuration, the capacitive load is increased and pre-register timing is negatively impacted. Therefore, reducing the number of register chips improves pre-register timing.

Reducing the number of register chips also simplifies the circuit board routing needs. A smaller number of register chips allows for more routing room to run signal traces. With more routing room, the layer count needed to manufacture the memory module can be reduced, for example, from ten layers to eight layers. This reduction in layers simplifies the manufacturing process and reduces manufacturing costs.

As described above, the present invention provides a DDR2 SDRAM memory module in which both pre-register and post-register timing is improved and manufacturing is simplified. These advantages are attained using a balanced topology to configure the memory chips and the register chips on the memory module in the manner described above. Accordingly, the invention improves the DDR2 design standard to provide further improvement in memory performance.

The foregoing description is intended to illustrate preferred embodiments of the present invention. However, the examples set forth above are not intended to limit the scope of the invention, which should be interpreted from the claims set forth below. It is to be understood that various modifications can be made to the illustrated examples without departing from the spirit and scope of the invention.

What is claimed is:

1. A DDR2 SDRAM memory module comprising a plurality of memory chips arranged bilaterally symmetrical on said memory module.

2. The memory module according to claim 1, further comprising a plurality of register chips, wherein each of said plurality of register chips is coupled to an equal number of said plurality of memory chips.

3. The memory module according to claim 2, wherein said plurality of memory chips places a substantially equal capacitive load on each of said plurality of register chips.

4. The memory module according to claim 2, wherein said memory module includes two register chips, wherein one of said two register chips is arranged on a first face of said memory module and is coupled to half of said plurality of memory chips, and the other of said two register chips is arranged on a second face of said memory module and is coupled to the other half of said plurality of memory chips.

5. The memory module according to claim 2, wherein said memory module includes four register chips, wherein two of said four register chips are arranged on a first face of said memory module and are coupled to half of said plurality of memory chips, and the other two of said four register chips are arranged on a second face of said memory module and are coupled to the other half of said plurality of memory chips.

6. The memory module according to claim 1, wherein said plurality of memory chips are arranged bilaterally symmetrical on a first face and a second face of said memory module with an equal number of said plurality of memory chips on each face.

7. The memory module according to claim 6, wherein said plurality of memory chips are arranged bilaterally symmetrical with respect to said plurality of register chips on each face.

8. The memory module according to claim 6, wherein said memory module comprises thirty-six memory chips with eighteen memory chips arranged bilaterally symmetrical on the first face of said memory module and the other eighteen memory chips arranged bilaterally symmetrical on the second face of said memory module.

9. The memory module according to claim 8, wherein said memory chips are arranged in a row of eight memory chips and a row of ten memory chips on each of the first and second faces of said memory module.

10. A DDR2 SDRAM memory module comprising:
a plurality of memory chips; and
a plurality of register chips,
wherein, each of said plurality of register chips is coupled to an equal number of said plurality of memory chips.

11. The memory module according to claim 10, wherein said plurality of memory chips places a substantially equal capacitive load on each of said plurality of register chips.

12. The memory module according to claim 10, wherein said memory module comprises two register chips, with one register chip arranged on each of a first face and a second face of said memory module.

13. A method for arranging a DDR2 SDRAM memory module comprising arranging a plurality of memory chips bilaterally symmetrical on the memory module.

14. The method according to claim 13, further comprising the steps of:
arranging a plurality of register chips on the memory module; and
coupling an equal number of the plurality of memory chips to each of the plurality of register chips.

15. The method according to claim 14, wherein the plurality of memory chips places a substantially equal capacitive load on each of the plurality of register chips.

16. The method according to claim 14, wherein one register chip is arranged on each of a first face and a second face of the memory module and each register chip is coupled to half of the memory chips.

17. The method according to claim 14, wherein a pair of register chips is arranged on each of a first face and a second face of the memory module and each pair of register chips is coupled to half of the memory chips.

18. The method according to claim 13, wherein the plurality of memory chips are arranged bilaterally symmetrical on a first face and a second face of the memory module with an equal number of memory chips on each face.

19. The method according to claim 18, wherein thirty-six memory chips are arranged on the memory module with eighteen memory chips arranged bilaterally symmetrical on the first face of the memory module and the other eighteen memory chips arranged bilaterally symmetrical on the second face of the memory module.

20. The method according to claim 18, wherein the memory chips are arranged in a row of eight memory chips and a row of ten memory chips on each of the first and second faces of the memory module.
